(19) United States
(12) Patent Application Publication
(10) Pub. No.: US 2012/0146814 A1
(43) Pub. Date: Jun. 14, 2012

(54) APPARATUS AND METHOD FOR GUIDING INTERSECTION ENTRY AND STANDBY TIME

(75) Inventor: Moo Seop KIM, Daejeon (KR)

(73) Assignee: Electronics and Telecommunications Research Institute, Daejeon (KR)

(21) Appl. No.: 13/307,282

(22) Filed: Nov. 30, 2011

(30) Foreign Application Priority Data
Dec. 13, 2010 (KR) 10-2010-0127079

(51) Int. Cl. G08G 1/096

(52) U.S. Cl. 340/929

(57) ABSTRACT

An apparatus for guiding an intersection entry and a standby time includes: a data receiver for receiving a control signal transmitted from an traffic signal control system; a vehicle travel information acquisition unit for acquiring a traveling direction and a travel speed of a vehicle; and a data analyzing unit for analyzing whether the vehicle can enter the intersection by analyzing position information and the traveling direction of the vehicle and the control signal to calculate an entry time into and a distance to the intersection or a standby time of the vehicle. The apparatus further includes a data output unit for providing whether to enter the intersection or the standby time of the vehicle to a driver of the vehicle.

### CROSS-REFERENCE(S) TO RELATED APPLICATION

The present invention claims priority of Korean Patent Application No. 10-2010-0127079, filed on Dec. 13, 2010, which is incorporated herein by reference.

### FIELD OF THE INVENTION

The present invention relates to a guide for entry time into and standby time at an intersection, and more particularly, to an intersection entry and standby time guide apparatus and method for informing a driver traveling of entry time into and standby time at an intersection in cooperation with an intersection traffic light control system.

### BACKGROUND OF THE INVENTION

In general, a vehicle entering an intersection is given an order of priority by a traffic light control system for controlling traffic of vehicles using traffic lights (red, yellow, and green) which are installed in every direction of the intersection.

A green light of the traffic lights is a signal for allowing a vehicle to enter an intersection, a yellow light is used to notice that a green light is being changed to a red light, and a red light is a signal of warning a vehicle not to enter an intersection.

In spite of these traffic light rules, frequent incidents and accidents occur in the intersection in reality.

In order to reduce accidents at intersections, a system for guiding a driver about traffic, that is a navigation device, in which a GPS receiver and a gyroscope or speed sensor are installed, for informing a user there is an intersection ahead of vehicle's traveling direction based on a vehicle speed and position or a GPS receiver is used.

However, the most difficulty a driver who drives a vehicle faces is that the driver cannot know how long time the entry signal, i.e., the green light remains at the time of entering an intersection. Most drivers decelerate vehicles by estimating the remaining time before entering the intersection, or in some cases accelerate vehicles to pass through the intersection very fast.

In addition, since a driver cannot know when a go signal (green light) in the traveling direction is received while a vehicle stops at intersection and waits for a traffic light, the driver does not recognize a change in the traffic light due to wandering attention and other miscellaneous jobs, and may interrupt traffic flow.

These two problems make a driver difficult to estimate the traffic light when a driver drives a vehicle to other city, at rush hour when traffic is high, or when traffic jam increases due to snow or rain, so that tailgating and traffic accident may be happened at intersections.

Therefore, an appropriate technical solution is required rather than an existing vehicle navigation system and driver's estimation dangerous of determining situation.

### SUMMARY OF THE INVENTION

In view of the above, the present invention provides an intersection entry and standby time guiding apparatus and method for informing a driver of time to change traffic signal at an intersection when a driver is entering the intersection or waiting for next traffic signal.

The objects of the invention are not limited thereto, and other objects that are not described above will be apparently understood by those skilled in the art from the following description.

In accordance with an aspect the present invention, there is an apparatus for guiding an intersection entry and a standby time, including: a data receiver for receiving a control signal transmitted from an traffic signal control system; a vehicle travel information acquisition unit for acquiring a traveling direction and a travel speed of a vehicle; a data analyzing unit for analyzing whether the vehicle can enter the intersection by analyzing position information and the traveling direction of the vehicle and the control signal to calculate an entry time into and a distance to the intersection or a standby time of the vehicle; and a data output unit for providing whether to enter the intersection or the standby time of the vehicle to a driver of the vehicle.

In accordance with another aspect the present invention, there is a method of guiding an intersection entry and a standby time including: analyzing travel information and position information of a vehicle when a vehicle starts to travel; when an intersection control signal is received during traveling of the vehicle, determining whether a current traffic signal is a go signal by analyzing the intersection control signal; calculating an entry time to the intersection and a remaining time of the go signal when the traffic signal is the go signal; and outputting the remaining time of the go signal and an intersection entry message allowing entering the intersection or a slow-travel and stopping guide message based on the calculated entry time and the remaining time of the go signal.

### BRIEF DESCRIPTION OF THE DRAWINGS

The objects and features of the present invention will become apparent from the following description of embodiments, given in conjunction with the accompanying drawings, in which:

FIG. 1 is a view illustrating an example to which an intersection entry and standby time guiding apparatus and method thereof in accordance with an embodiment of the present invention are applied;

FIG. 2 is a block diagram showing configurations of an traffic signal control system and an intersection entry and standby time guiding apparatus in accordance with an embodiment of the present invention; and

FIG. 3 is a flowchart illustrating a process of guiding entry time into and standby time at an intersection in accordance with the embodiment of the present invention.

### DETAILED DESCRIPTION OF THE EMBODIMENT

Embodiments of the present invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law.

Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of respective blocks of block diagrams attached herein and respective steps of a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective steps of the sequence diagram.

Moreover, the respective blocks or the respective steps may indicate modules, segments, or some of codes including at least one executable instruction for executing a specific logical function(s). In several alternative embodiments, it is noticed that functions described in the blocks or the steps may run out of order. For example, two successive blocks and steps may be substantially executed simultaneously or often in reverse order according to corresponding functions.

Hereinafter, an embodiment of the present invention will be described in detail with the accompanying drawings which form a part hereof.

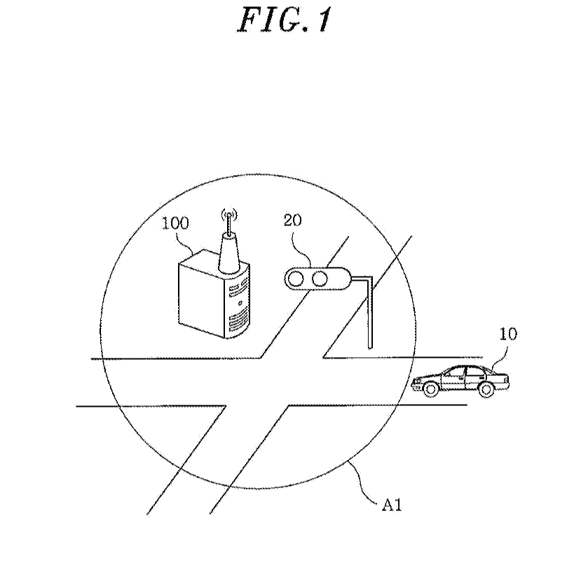

FIG. 1 is a view illustrating an example to which an intersection entry and standby time guiding apparatus and method in accordance with an embodiment of the present invention are applied, and which includes an traffic signal control system 100 located at a roadside of the intersection for converting data related to traffic signal control into a wireless signal to radially transmit the same within a predetermined radius.

As illustrated in FIG. 1, a vehicle 10 travels for a target place and there may be many intersections on the travel path.

Meanwhile, when the vehicle is traveling, the vehicle may travel along a path determined by using a travel path guide system such as a navigation system.

A driver of this vehicle 10 checks a traffic signal of a traffic light 20 at an intersection in advance to pass through the intersection, enters the intersection when the traffic signal of the traffic light 20 is a go signal, e.g., a green light, and stops the vehicle at the intersection when the traffic signal is a stop signal (red light).

The driver of the vehicle 10 decelerates the vehicle 10 to stop or maintains the travel mode to pass through the intersection when information is received from the traffic signal control system 100, based on a message provided from an intersection entry and standby time guiding apparatus 200 in accordance with the embodiment of the present invention.

The intersection entry and standby time guiding apparatus in accordance with the embodiment of the present invention receives information in advance from the traffic signal control system 100 that exists on the travel path of the vehicle 10 and checks and informs entry time into or standby time at the intersection to the driver, so that entry into the intersection due to a driver's mistake of judgment may be prevented.

When the vehicle 10 reaches in a receivable region A1 where an intersection traffic control signal is received from the traffic signal control system 100, the vehicle 10 receives the intersection traffic control signal wirelessly transmitted from the traffic signal control system 100 and analyzes the intersection traffic control signal using the intersection entry and standby time guiding apparatus 200 in accordance with the embodiment of the present invention to inform the analysis result to the driver so that the driver may judge whether to enter the intersection or not.

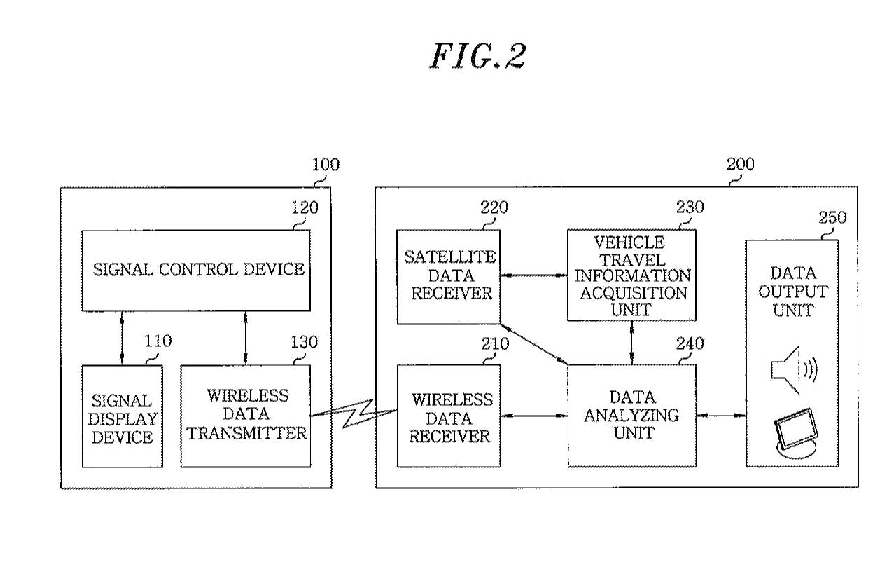

The traffic signal control system 100 includes a signal display device 110 for displaying a traffic signal of the traffic light 20, a signal control device 120 for controlling a traffic signal of the traffic light 20, a wireless data transmitter 130, and the like, as shown in FIG. 2.

The signal display device 110 displays a traffic signal of the traffic light 20, and more specifically, at least one signal display device 110 is installed in every accessing path to an intersection to display signal information of giving an order of priority of allowing vehicle 10 to enter.

In order to control the flow of the vehicles at the intersection, the signal control device 120 controls the signal display device 110 using a preset traffic control signal, generates an intersection control signal, and transmits the generated intersection control signal through the wireless data transmitter 130. In other words, the signal control device 120 generates the intersection control signal including a current traffic signal information, a changing sequence of the traffic light 20, a signal changing period of the traffic light 20, and intersection location information, and then transmits the same through the wireless data transmitter 130.

The wireless data transmitter 130 transmits the intersection control signals received from the signal control device 120 using a conventional wireless communication scheme, transmission/reception frequency information and the like. The reception region A1 where the intersection control signal can be received may be changed based on a wireless data transmission scheme used in the wireless data transmitter 130.

The wireless data transmitter 130 performs one-way communication with vehicles accessing an intersection. For example, the wireless data transmitter 130 performs communications with the vehicles using a scheme of transmitting data from the intersection in radial direction, a scheme of transmitting data only in a specific direction using a directional antenna, or the like.

The intersection location information in the intersection control signal may be used with position information provided by a GPS or a navigation system in a travelling vehicle, e.g., position information of the vehicle to determine a remaining distance and a travelling direction from the vehicle 10 to the intersection.

In addition, the traffic signal of the traffic light 20, a remaining time of a current traffic signal, and changing sequence and period of intersection traffic signals may be used to inform a driver of the type of the traffic light 20 of an intersection at which the vehicle 10 will enter, a remaining distance, and whether the vehicle 10 may enter at a current travelling speed before the traffic signal is changed.

Meanwhile, the wireless data transmitter 130 of the traffic signal control system 100 in accordance with the embodiment of the present invention may transmit wireless communication scheme and frequency information on use by including them in the intersection traffic control signal. Then, the vehicle 10 may check the type of the transmitted control signal in advance to effectively analyze the transmitted control signal based on such information.

The intersection entry and standby time guiding apparatus 200, as shown in FIG. 2, includes a wireless data receiver 210, a satellite data receiver 220, a vehicle travel information acquisition unit 230, a data analyzing unit 240, a data output unit 250 and the like.

The wireless data receiver 210 receives the intersection control signal transmitted from the wireless data transmitter 130 of the traffic signal control system 100 to extract necessary data therefrom, and provides the extracted data to the data analyzing unit 240.

The satellite data receiver 220 extracts position information of the vehicle 10 by using a signal received from a satellite system (not shown) and provides the extracted position information to the vehicle travel information acquisition unit 230 and the data analyzing unit 240.

Although, in the embodiment of the present invention, the satellite data receiver 220 is illustrated to be included in the intersection entry and standby time guiding apparatus 200, a system including a module capable of receiving satellite data such as a navigation system or a vehicle black box system may be used. In other words, by interworking the intersection entry and standby time guiding apparatus 200 in accordance with the embodiment of the present invention with the system including the module, the position information of a vehicle may be received from the system or an intersection entry and standby time guiding function may be applied to the system including the module.

The vehicle travel information acquisition unit 230 acquires travel data such as a current traveling direction of a vehicle and a travel speed using a gyroscope, a position sensor, a speed sensor and the like which are mounted in the vehicle. In this case, the vehicle travel information acquisition unit 230 also uses the position information of a vehicle received from the satellite data receiver 220 to acquire the travel data.

The data analyzing unit 240 calculates a time taking to enter the intersection based on the travel data of the vehicle and the intersection control signal, analyzes the possibility to enter the intersection, and informs the result to a driver through the data output unit 250.

Also, in case where a vehicle stops before an intersection and waits for a go signal (green signal), the data analyzing unit 240 calculates standby time that the driver should standby until the driver receives the go signal and informs the calculated result to the driver through the data output unit 250.

As such, in order to analyze the standby time and possibility to entry an intersection, the data analyzing unit 240 uses the intersection control signal and the intersection position information transmitted from the wireless data receiver 210, the current position information of a vehicle received from the satellite data receiver 220 and the vehicle speed and the direction data received from the vehicle travel information acquisition unit 230. In other words, in a case where a vehicle travels to enter an intersection, the data analyzing unit 240 calculates a distance to the intersection by using a position of the intersection received from the wireless data receiver 210 and the position of a vehicle transmitted from the satellite data receiver 220, and calculates a time taking to enter the intersection by using the current travel speed, direction of a vehicle and the distance to the intersection. Then, whether to enter an intersection is determined by considering the time taking to enter the intersection, and the current traffic signal information and the remaining time of the traffic signal based on the intersection control signal received by the wireless data receiver 210.

In addition, in a case where a vehicle is already stopped at the intersection and is waiting for a go signal, the data analyzing unit 240 calculates the standby time until the go signal is turned on by using the current traffic signal information, the remaining time of the traffic signal, and the changing period of the traffic signal among the traffic signals received by the wireless data receiver 210.

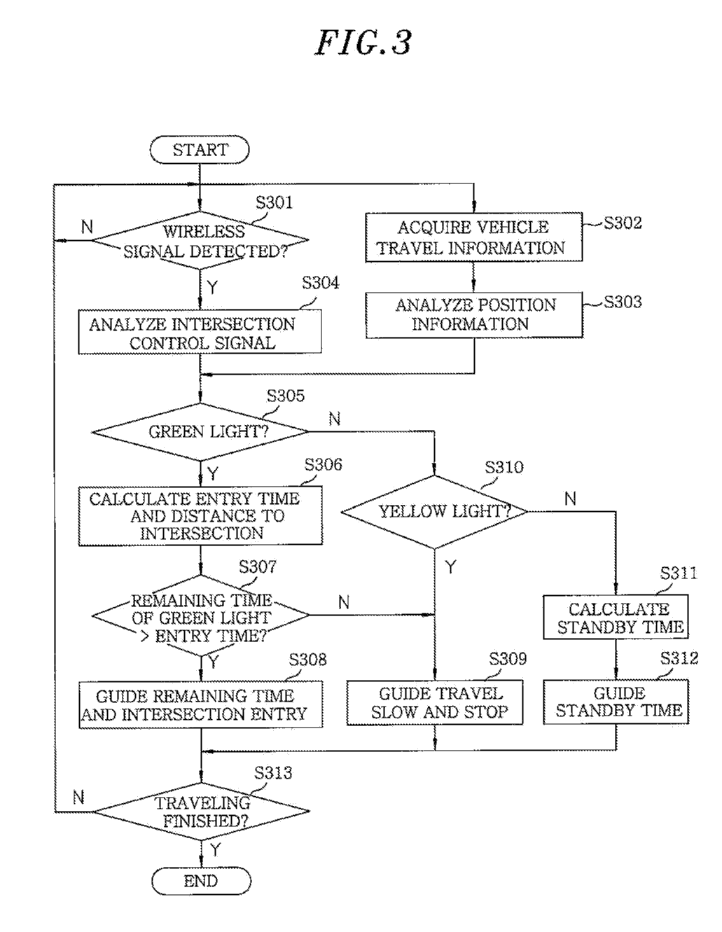

A process in which the data analyzing unit 240 calculates the remaining time and the standby time will be described with reference to FIG. 3.

FIG. 3 is a flowchart illustrating a process of guiding entry time into and standby time at an intersection in accordance with the embodiment of the present invention.

As illustrated in FIG. 3, when a vehicle travels, the intersection entry and standby time guiding apparatus 200 checks whether an intersection control signal transmitted from the traffic signal control system 100 through the wireless data receiver 210 is detected or not in step S301.

When the intersection control signal is not detected as a result of checking in step S301, the process continues to perform the operation of step S301 in which the vehicle travels while checking whether the intersection control signal is detected. As such, when the vehicle is traveling, the vehicle travel information acquisition unit 230 acquires travel information on the vehicle such as a travel speed and direction of a vehicle using various sensor devices (not shown) mounted in the vehicle in step S302, and the satellite data receiver 220 receives satellite information to analyze the current position information on the vehicle in step S303.

When the intersection control signal is detected as a result of checking in step S301, the data analyzing unit 240 extracts data such as current traffic signal information at the intersection, the remaining time of the current traffic signal, and the signal changing period from the intersection control signal in step S304.

Then, it is determined whether the current traffic signal is a green light based on the current traffic signal information in step S305.

When the current traffic signal is a green light, the data analyzing unit 240 calculates a distance from a current position to the intersection and a time taking to enter the intersection when the vehicle travels at the current travel speed using the intersection control signal analysis result, the vehicle travel information, and the position information of the vehicle in step S306.

Next, the data analyzing unit 240 calculates entry time into and the distance to the intersection and compares the remaining time of a green light with the entry time in step S307.

When the remaining time is longer than the entry time as a result of the comparison in step S307, the data analyzing unit 240 generates information for informing an estimated entry time taking to enter the intersection and whether to enter the intersection during the green signal and outputs the generated information through the data output unit 250 so that a driver may be informed the remaining time and guided for entering the intersection in step S308.

When the remaining time is shorter than or equal to the entry time as a result of the comparison in step S307, the data analyzing unit 240 generates information for informing the driver to travel slow or to stop and outputs the generated information through the data output unit 250 in step S309.

When the current traffic signal is not a green light as a result of the determination in step S305, the data analyzing unit 240 determines whether the current traffic signal is yellow in step S310.

When the current traffic signal is yellow as a result of the determination in step S310, the data analyzing unit 240 generates information for informing the driver to travel slow or to stop and outputs the generated information through the data output unit 250 in step S309.

In step S309, the data analyzing unit 240 further outputs the remaining time until the intersection traffic signal is changed to the data output unit 250 for the driver to judge clearly.

When the current traffic signal is not yellow (i.e., red) as a result of the determination in step S310, the data analyzing unit 240 calculates time to wait for till a following go signal (green signal) using the traffic signal changing period and the remaining time of the current traffic signal information of the intersection control signal in step S311 because the vehicle may be standing by at the intersection due to a red light, and outputs the calculated standby time to the driver through the data output unit 250 in real time in step S312. Further, when the current traffic signal is not yellow (i.e., red) in step S310 and the vehicle is proceeding toward the intersection, the data analyzing unit 240 may output information for informing the driver to stop at the intersection with the calculated standby time to the driver through the data output unit 250 in real time. After informing to the driver in the above-mentioned steps, the same steps can be repeated periodically during the travel of the vehicle. Therefore, after the guide for the entry into the intersection, whether the vehicle is still traveling must be determined in step S313.

When the vehicle continues to travel as a result of the determination in step S313, the intersection entry and standby time guiding apparatus 200 returns to step S301 to repeatedly perform the following steps. The same process is repeatedly carried out using a wireless signal when it is received again. On the contrary, when the vehicle finishes the travel, the control flow of FIG. 3 is ended because there is no further travel.

In accordance with the embodiment of the present invention, the remaining time of the go signal and the traffic signal standby time at the intersection are informed to a driver who enters the intersection so that the entry into the intersection by estimation of the driver is prevented to safely drive a vehicle and prevent an accident.

In addition, the present invention may be additionally applied to a navigation system, a GPS receiver, a black box device, etc., which are conventionally attached to a vehicle to perform complementary function, thereby improving driver's convenience.

While the invention has been shown and described with respect to the particular embodiments, it will be understood by those skilled in the art that various changes and modifications may be made without departing from the scope of the invention as defined in the following claims.

What is claimed is:

1. An apparatus for guiding an intersection entry and a standby time, comprising:
a data receiver for receiving a control signal transmitted from an traffic signal control system;
a vehicle travel information acquisition unit for acquiring a traveling direction and a travel speed of a vehicle;
a data analyzing unit for analyzing whether the vehicle can enter the intersection by analyzing position information and the traveling direction of the vehicle and the control signal to calculate an entry time into and a distance to the intersection or a standby time of the vehicle; and
a data output unit for providing whether to enter the intersection or the standby time of the vehicle to a driver of the vehicle.

2. The apparatus of claim 1, wherein the control signal includes position information of the intersection, a changing sequence of an intersection traffic light, and a changing period of the intersection traffic light.

3. The apparatus of claim 1, wherein the data analyzing unit calculates a remaining time of a go traffic signal based on the control signal when the vehicle is traveling by analyzing the position information and the traveling direction of the vehicle, or a remaining time until a go traffic signal is turned on based on the control signal when the vehicle stops at the intersection and waits for the traffic signal.

4. The apparatus of claim 3, wherein the data analyzing unit determines whether the vehicle can enter the intersection by comparing the remaining time of the go traffic signal with the entry time for the vehicle to enter the intersection when the vehicle is traveling and the traffic light of the intersection is the go traffic signal.

5. The apparatus of claim 1, wherein the vehicle travel information acquisition unit receives the position information and the traveling direction of the vehicle from a sensor device or a satellite signal receiver.

6. The apparatus of claim 5, wherein the satellite signal server includes a system including a module capable of receiving satellite data such as a navigation system, a position information providing system, or a vehicle black box system.

7. A method of guiding an intersection entry and a standby time, comprising:
analyzing travel information and position information of a vehicle when a vehicle starts to travel;
when an intersection control signal is received during traveling of the vehicle, determining whether a current traffic signal is a go signal by analyzing the intersection control signal;
calculating an entry time to the intersection and a remaining time of the go signal when the traffic signal is the go signal; and
outputting the remaining time of the go signal and an intersection entry message allowing entering the intersection or a slow-travel and stopping guide message based on the calculated entry time and the remaining time of the go signal.

8. The method of claim 7, further comprising outputting a standby time of the intersection traffic signal when the current traffic signal is a stop signal.

9. The method of claim 7, further comprising outputting the slow-travel and stopping guide message before the intersection when the current traffic signal is not the go signal and a stop signal.

10. The method of claim 7, wherein the intersection control signal includes the current traffic signal, the position information of the intersection, a changing sequence of an intersection traffic signal and a changing period.
